(19) United States
(12) Patent Application Publication
(10) Pub. No.: US 2012/0043811 A1
(43) Pub. Date: Feb. 23, 2012

(54) POWER SUPPLY HAVING IMPROVED SYSTEM EFFICIENCY

(75) Inventors: Yeon Ho JEONG, Seoul (KR); Chong Eun KIM, Daejeon (KR); Jong Pil KIM, Gwacheon (KR); Don Sik KIM, Gunpo (KR)

(73) Assignee: SAMSUNG ELECTRO-MECHANICS CO., LTD., Suwon (KR)

(21) Appl. No.: 13/026,480

(22) Filed: Feb. 14, 2011

(30) Foreign Application Priority Data
Aug. 18, 2010 (KR) 10-2010-0079985

(51) Int. Cl. H02M 7/217

(52) U.S. Cl. 307/31

(57) ABSTRACT

A power supply having improved system efficiency includes: a standby stage converting a DC voltage into an operating voltage and a first standby voltage, which have a preset magnitude, and supplying the first standby voltage to a standby output terminal; a DC/DC stage supplied with the operating voltage from the standby stage, converting the DC voltage into a main voltage having a preset magnitude, and supplying the main voltage to a main output terminal; and a main/standby stage converting the main voltage from the DC/DC stage into a second standby voltage having a preset magnitude, and supplying the second standby voltage to the standby output terminal.

### CROSS-REFERENCE TO RELATED APPLICATIONS

This application claims the priority of Korean Patent Application No. 10-2010-0079985 filed on Aug. 18, 2010, in the Korean Intellectual Property Office, the disclosure of which is incorporated herein by reference.

### BACKGROUND OF THE INVENTION

1. Field of the Invention

The present invention relates to a power supply which is applicable to a server, and more particularly, to a power supply which can improve the system efficiency of a standby voltage supply system by supplying a standby voltage using a main voltage.

2. Description of the Related Art

In order to generate a standby voltage, a conventional power supply for a server generally uses a flyback converter having a simple structure. However, such a flyback converter has low efficiency due to high voltage stress and hard switching.

A conventional power supply for a server is designed so that a standby stage supplies an operating voltage and a standby voltage using a DC voltage from a power factor correction (PFC) unit, and a DC/DC stage is supplied with the operating voltage from the standby stage and generates a main voltage using the DC voltage from the PFC unit.

In the conventional power supply for the server, the standby stage generally uses a flyback converter, and the efficiencies of the PFC unit, the DC/DC stage, and the standby stage are about 98%, 96%, and 80%, respectively, when an input voltage of about 230 Vac is inputted thereto and a load thereof is 50%.

In the conventional power supply for the server, the efficiency of the standby stage is very low, even though the weight of the standby stage is low as compared to the main voltage supply unit. Consequently, the efficiency of an overall server system to which the power supply is applied will be lowered.

### SUMMARY OF THE INVENTION

An aspect of the present invention provides a power supply which can improve the efficiency of a standby voltage supply system by supplying a standby voltage using a main voltage.

According to an aspect of the present invention, there is provided a power supply having improved system efficiency, including: a standby stage converting a DC voltage into an operating voltage and a first standby voltage, which have a preset magnitude, and supplying the first standby voltage to a standby output terminal; a DC/DC stage supplied with the operating voltage from the standby stage, converting the DC voltage into a main voltage having a preset magnitude, and supplying the main voltage to a main output terminal; and a main/standby stage converting the main voltage from the DC/DC stage into a second standby voltage having a preset magnitude, and supplying the second standby voltage to the standby output terminal.

According to another aspect of the present invention, there is provided a power supply having, improved system efficiency, including: a power factor correction (PFC) unit converting an AC voltage into a DC voltage having a preset magnitude; a standby stage converting the DC voltage from the PFC unit into an operating voltage and a first standby voltage, which have a preset magnitude, and supplying the first standby voltage to a standby output terminal; a DC/DC stage supplied with the operating voltage from the standby stage, converting the DC voltage into a main voltage having a preset magnitude, and supplying the main voltage to a main output terminal; and a main/standby stage converting the main voltage from the DC/DC stage into a second standby voltage having a preset magnitude, and supplying the second standby voltage to the standby output terminal.

According to another aspect of the present invention, there is provided a power supply having improved system efficiency, including: a standby stage converting a DC voltage into an operating voltage and a first standby voltage, which have a preset magnitude, and supplying the first standby voltage to a standby output terminal; a DC/DC stage supplied with the operating voltage from the standby stage, converting the DC voltage into a main voltage having a preset magnitude, and supplying the main voltage to a main output terminal; a main/standby stage converting the main voltage from the DC/DC stage into a second standby voltage having a preset magnitude, and supplying the second standby voltage to the standby output terminal; and a protection circuit unit connected between an output terminal of the standby stage and the standby output terminal, and opening a voltage supply line connected to the output terminal of the standby stage.

The power supply may further include a power factor correction (PFC) unit converting an AC voltage into the DC voltage and supplying the DC voltage to the DC/DC stage and the standby stage.

The main/standby stage may include a first diode having an anode connected to the main output terminal and a cathode connected to the standby output terminal, the first diode being turned on by the main voltage from the DC/DC stage and supplying the second standby voltage to the standby output terminal.

The protection circuit unit may include a protection diode having an anode connected to the output terminal of the standby stage and a cathode connected to the standby output terminal, the protection diode being turned off when the second standby voltage is supplied.

The protection circuit unit may include a protection switching element connected between the output terminal of the standby stage and the standby output terminal, the protection switching element being turned off when the second standby voltage is supplied.

The main/standby stage may include a first switching element connected between the main output terminal and the standby output terminal, the first switching element being turned on by a first switching control signal and supplying the main voltage from the DC/Dc stage to the standby output terminal.

The protection circuit unit may include a protection diode having an anode connected to the output terminal of the standby stage and a cathode connected to the standby output terminal, the protection diode being turned off when the second standby voltage is supplied.

The protection circuit unit may include a protection switching element connected between the output terminal of the standby stage and the standby output terminal, the protection switching element being turned off when the second standby voltage is supplied.

The main/standby stage may include a voltage regulator converting the main voltage from the DC/DC stage into a preset voltage; and a second diode having an anode connected to an output terminal of the voltage regulator and a cathode connected to the standby output terminal, the second diode being turned on by an output voltage of the voltage regulator and supplying the second standby voltage to the standby output terminal.

The protection circuit unit may include a protection diode having an anode connected to the output terminal of the standby stage and a cathode connected to the standby output terminal, the protection diode being turned off when the second standby voltage is supplied.

The protection circuit unit may include a protection switching element connected between the output terminal of the standby stage and the standby output terminal, the protection switching element being turned off when the second standby voltage is supplied.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of a power supply having improved system efficiency according to an embodiment of the present invention;

FIG. 2 is an exemplary diagram of a main/standby stage according to a first implementation of the present invention;

FIG. 3 is an exemplary diagram of a main/standby stage according to a second implementation of the present invention;

FIG. 4 is an exemplary diagram of a main/standby stage according to a third implementation of the present invention;

FIG. 5 is an exemplary diagram of the power supply having improved system efficiency according to a first modification of the present invention;

FIG. 6 is an exemplary diagram of the power supply having improved system efficiency according to a second modification of the present invention; and

FIG. 7 is an operational flowchart of the power supply having improved system efficiency according to an embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the thicknesses of layers and regions are exaggerated for clarity. Like reference numerals in the drawings denote like elements, and thus their description will be omitted.

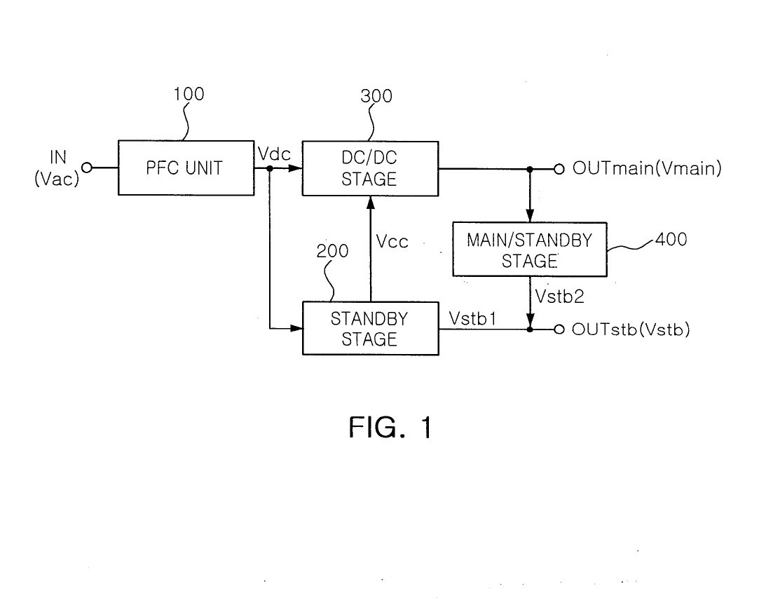

FIG. 1 is a block diagram of a power supply having improved system efficiency according to an embodiment of the present invention.

Referring to FIG. 1, the power supply having improved efficiency according to the embodiment of the present invention includes a standby stage 200, a DC/DC stage 300, and a main/standby stage 400. The standby stage 200 converts a DC voltage Vdc into an operating voltage Vcc and a first standby voltage Vstb1, which have a preset magnitude, and supplies the first standby voltage Vstb1 to a standby output terminal OUTstb. The DC/DC stage 300 is supplied with the operating voltage Vcc from the standby stage 200, converts the DC voltage Vdc into a main voltage Vmain having a preset magnitude, and supplies the main voltage Vmain to a main output terminal OUTmain. The main/standby stage 400 converts the main voltage Vmain from the DC/DC stage 300 into a second standby voltage Vstb2 having a preset magnitude, and supplies the second standby voltage Vstb2 to the standby output terminal OUTstb.

In addition, the power supply according to the embodiment of the present invention may further include a power factor correction (PFC) unit which converts an AC voltage into the DC voltage having a preset magnitude, and supplies the DC voltage to the DC/DC stage 300 and the standby stage 200.

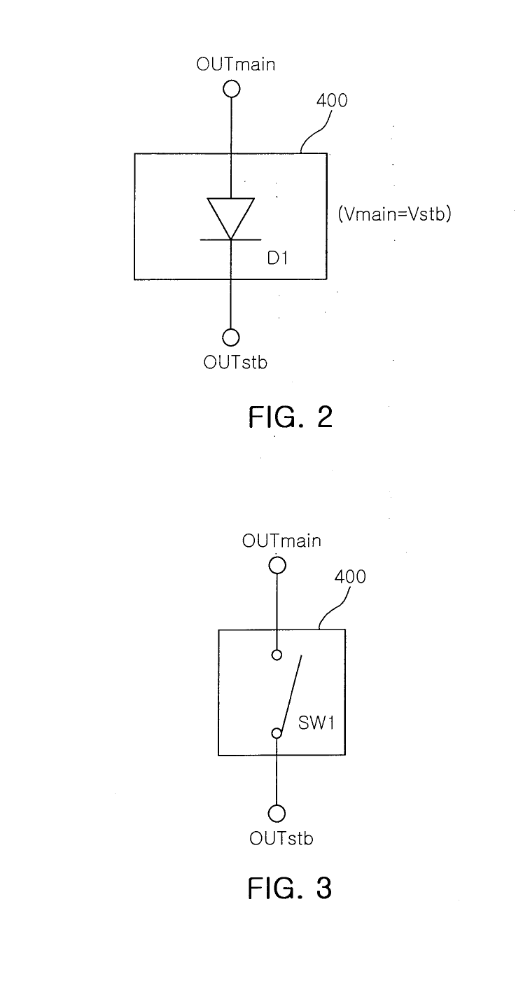

FIG. 2 is an exemplary diagram of the main/standby stage according to a first implementation of the present invention.

Referring to FIG. 2, the main/standby stage 400 may include a first diode D1 having an anode connected to the main output terminal OUTmain and a cathode connected to the standby output terminal OUTstb.

The first diode D may be configured to be turned on by the main voltage Vmain from the DC/DC stage 300 and supply the second standby voltage Vstb2 to the standby output terminal OUTstb.

FIG. 3 is an exemplary diagram of the main/standby stage according to a second implementation of the present invention.

Referring to FIG. 3, the main/standby stage 400 may include a first switching element SW1 connected between the main output terminal OUTmain and the standby output terminal OUTstb.

The first switching element SW1 may be configured to be turned on by a first switching control signal and supply the main voltage Vmain from the DC/DC stage 300 to the standby output OUTstb.

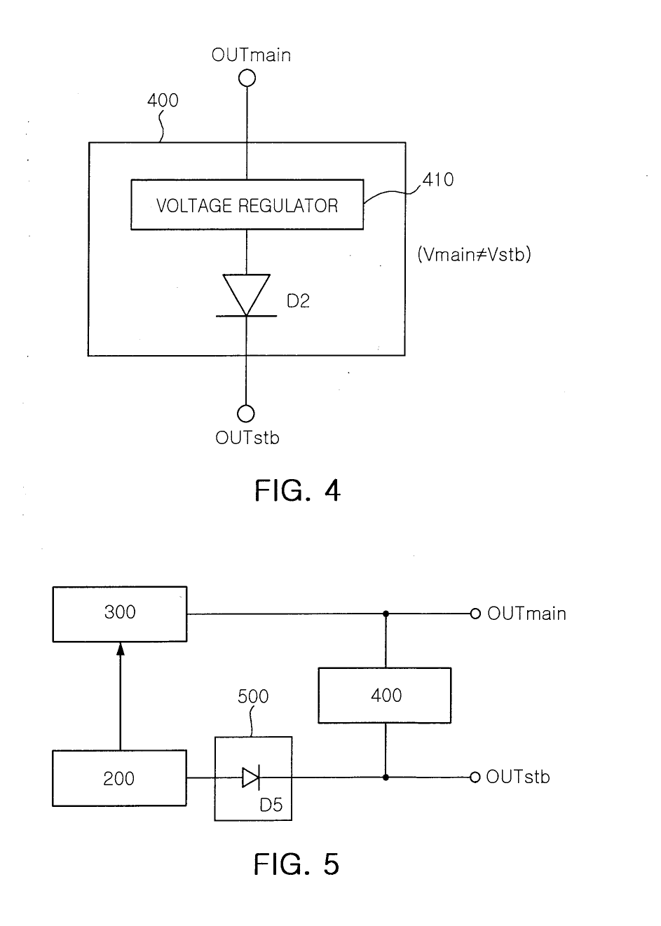

FIG. 4 is an exemplary diagram of the main/standby stage according to a third implementation of the present invention.

Referring to FIG. 4, the main/standby stage 400 may include a voltage regulator 410 and a second diode D2. The voltage regulator 410 converts the main voltage Vmain from the DC/DC stage into a preset voltage. The second diode D2 has an anode connected to an output terminal of the voltage regulator 410 and a cathode connected to the standby output terminal OUTstb.

The second diode D2 may be configured to be turned on by the output voltage of the voltage regulator 410 and supply the second standby voltage Vstb2 to the standby output terminal OUTstb.

FIG. 5 is an exemplary diagram of the power supply having improved system efficiency according to a first modification of the present invention.

Referring to FIG. 5, the power supply according to the first modification of the present invention may include a protection circuit unit 500 which is connected between the output terminal of the standby stage 200 and the standby output terminal OUTstb and opens a voltage supply line connected to the output terminal of the standby stage 200 when the second standby voltage Vstb2 is supplied.

The protection circuit unit 500 may include a protection diode D5 having an anode connected to the output terminal of the standby stage 200 and a cathode connected to the standby output terminal OUTstb.

The protection diode D5 may be configured to be turned off when the second standby voltage Vstb2 is supplied.

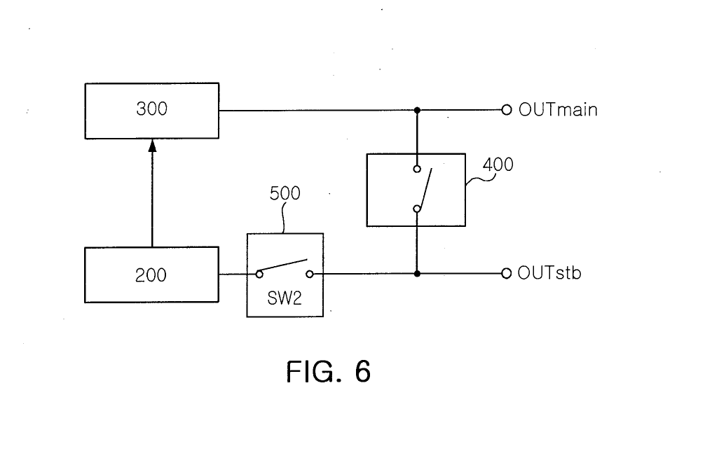

FIG. 6 is an exemplary diagram of the power supply having improved system efficiency according to a second modification of the present invention.

Referring to FIG. 6, the protection circuit unit 500 may include a protection switching element SW2 connected between the output terminal of the standby stage 200 and the standby output terminal OUTstb.

The protection switching element SW2 may be configured to be turned off when the second standby voltage Vstb2 is supplied.

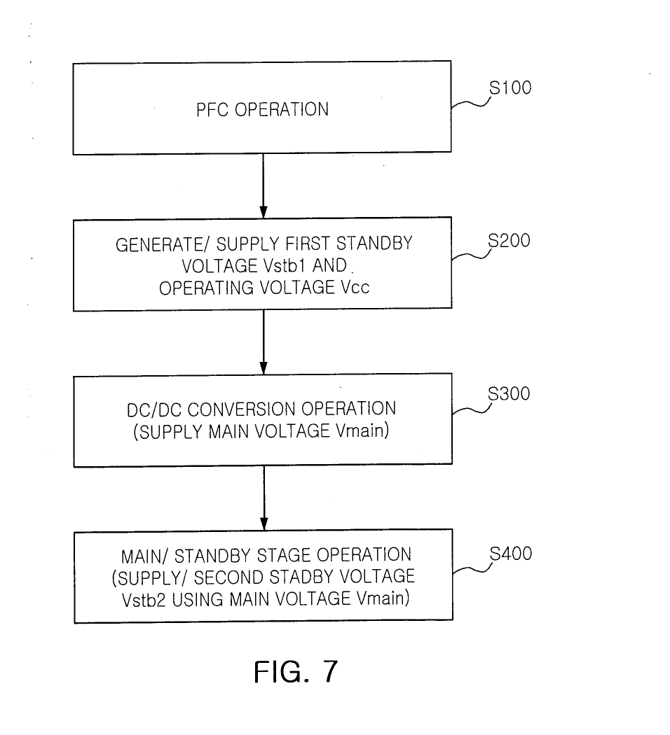

FIG. 7 is an operational flowchart of the power supply having improved system efficiency according to an embodiment of the present invention. In FIG. 7, S100 is a process in which the PFC unit 100 performs a PFC operation, and S200 is a process in which the standby stage 200 generates and supplies the first standby voltage Vstb1 and the operating voltage Vcc. S300 is a process in which the DC/DC stage 300 performs the DC/DC conversion operation, and S400 is a process in which the main/standby stage 400 operates to supply the second standby voltage Vstb2 using the main voltage Vmain.

Hereinafter, the operation and effect of the present invention will be described with reference to the accompanying drawings.

The power supply having improved system efficiency according to the embodiment of the present invention will be described below with reference to FIGS. 1 through 7. First, in the power supply illustrated in FIG. 1, the PFC unit 100 may convert the AC voltage of 90-266 Vac into the preset DC voltage (e.g., 380 Vdc), and supply the DC voltage to the DC/DC stage 300 and the standby stage 200 (S100 of FIG. 7).

The standby stage 200 may convert the DC voltage Vdc from the PFC unit 100 into the operating voltage Vcc (e.g., 10 Vdc) and the first standby voltage Vstb1 (e.g., 10 Vdc), and supply the first standby voltage Vstb1 to the standby output terminal OUTstb (S200 of FIG. 7). In this case, the first standby voltage Vstb1 becomes the standby voltage Vstb.

In addition, the DC/DC stage 300 may be supplied with the operating voltage. Vcc from the standby stage 200 to operate the internal circuit thereof. Accordingly, the DC/DC stage 300 may convert the DC voltage Vdc into the preset main voltage Vmain (e.g., 12 Vdc), and supply the main voltage Vmain (e.g., 12 Vdc) to the main output terminal OUTmain (S300 of FIG. 7).

The main/standby stage 400 may convert the main voltage Vmain from the DC/DC stage 300 into the preset second standby voltage Vstb2 (e.g., 10 V), and supply the second standby voltage Vstb2 to the standby output terminal OUTstb (S400 of FIG. 7). In this case, the second standby voltage Vstb2 becomes the standby voltage Vstb.

Referring to FIG. 2, in a case in which the main voltage Vmain is equal to the standby voltage Vstb, the main/standby stage 400 may include the first diode D1 as the first implementation. The first diode D1 may be turned on by the main voltage Vmain from the DC/DC stage 300 and supply the second standby voltage Vstb2 to the standby output terminal OUTstb.

Referring to FIG. 3, in a case in which the main voltage Vmain is equal to the standby voltage Vstb, the main/standby stage 400 may include the first switching element SW1 as the second implementation. The first switching element SW1 may be turned on by the first switching control signal and supply the main voltage Vmain from the DC/DC stage 300 to the standby output terminal OUTstb.

For example, in a case in which the main voltage Vmain is supplied from the DC/DC stage 300, the power supply may be configured to provide the first switching control signal. In this case, the first switching element SW1 may be turned off by the first switching control signal.

Referring to FIG. 4, in a case in which the main voltage Vmain is not equal to the standby voltage Vstb, the main/standby stage 400 may include the voltage regulator 410 and the second diode D2 as the third implementation.

The voltage regulator 410 may convert the main voltage Vmain from the DC/DC stage 300 into the preset voltage.

The second diode D2 may be turned on by the output voltage of the voltage regulator 410 and supply the second standby voltage Vstb2 to the standby output terminal OUTstb.

As illustrated in FIG. 5, the power supply having improved system efficiency according to the first modification may include the protection circuit unit 500.

The protection circuit unit 500 is connected between the output terminal of the standby stage 200 and the standby output terminal OUTstb and opens the voltage supply line connected to the output terminal of the standby stage 200 when the second standby voltage Vstb2 is supplied. Therefore, it is possible to prevent the second standby voltage Vstb2 from being introduced to the standby stage 200, thereby protecting the standby stage 200.

As an example, in a case in which the protection circuit unit 500 includes the protection diode D5, the protection diode D5 may be turned off when the second standby voltage Vstb2 is supplied.

For example, when the first and second standby voltages Vstb1 and Vstb2 are 10 Vdc, an offset state is initiated in the protection diode D5.

As illustrated in FIG. 6, the protection circuit unit 500 of the power supply having improved system efficiency according to the second modification may include the protection switching element SW2. The protection switching element SW2 may be turned off when the second standby voltage Vstb2 is supplied.

For example, when the second standby voltage Vstb2 is supplied, the power supply may be configured to provide a protection switching control signal. In this case, the protection switching element SW2 may be turned off by the protection switching control signal.

As described above, when the DC/DC stage 300 does not operate, the output voltage can be obtained from the output voltage of the PFC unit 100 through the standby stage 200. When the DC/DC stage 300 operates, the output voltage can be obtained through the DC/DC stage 300 and the main/standby stage 400.

In addition, when the AC input voltage is about 230 Vac and the load thereof is 50%, the efficiencies of the PFC unit 100, the DC/DC stage 300, and the standby stage 200 are about 98%, 96%; and 80%, respectively, and the efficiency of the voltage regulator 410 of the main/standby stage 400 is about 92%.

Accordingly, the efficiency of the DC/DC stage 300 and the voltage regulator 410 is 88%, which is improved by about 8%, as compared to a case in which the standby stage is obtained through the standby stage.

In particular, when the standby voltage is equal to the main voltage, the voltage regulator of the main/standby stage can be removed. In this case, the efficiency of the power supply can be improved by about 16%.

As set forth above, according to exemplary embodiments of the invention, the efficiency of the standby voltage supply system can be improved by supplying the standby voltage using the main voltage.

While the present invention has been shown and described in connection with the exemplary embodiments, it will be apparent to those skilled in the art that modifications and variations can be made without departing from the spirit and scope of the invention as defined by the appended claims.

What is claimed is:

1. A power supply having improved system efficiency, comprising:
a standby stage converting a DC voltage into an operating voltage and a first standby voltage, which have a preset magnitude, and supplying the first standby voltage to a standby output terminal;
a DC/DC stage supplied with the operating voltage from the standby stage, converting the DC voltage into a main voltage having a preset magnitude, and supplying the main voltage to a main output terminal; and
a main/standby stage converting the main voltage from the DC/DC stage into a second standby voltage having a preset magnitude, and supplying the second standby voltage to the standby output terminal.

2. The power supply of claim 1, wherein the main/standby stage comprises a first diode having an anode connected to the main output terminal and a cathode connected to the standby output terminal, the first diode being turned on by the main voltage from the DC/DC stage and supplying the second standby voltage to the standby output terminal.

3. The power supply of claim 1, wherein the main/standby stage comprises a first switching element connected between the main output terminal and the standby output terminal, the first switching element being turned on by a first switching control signal and supplying the main voltage from the DC/DC stage to the standby output terminal.

4. The power supply of claim 1, wherein the main/standby stage comprises:
a voltage regulator converting the main voltage from the DC/DC stage into a preset voltage; and
a second diode having an anode connected to an output terminal of the voltage regulator and a cathode connected to the standby output terminal, the second diode being turned on by an output voltage of the voltage regulator and supplying the second standby voltage to the standby output terminal.

5. A power supply having improved system efficiency, comprising:
a power factor correction (PFC) unit converting an AC voltage into a DC voltage having a preset magnitude;
a standby stage converting the DC voltage from the PFC unit into an operating voltage and a first standby voltage, which have a preset magnitude, and supplying the first standby voltage to a standby output terminal;
a DC/DC stage supplied with the operating voltage from the standby stage, converting the DC voltage into a main voltage having a preset magnitude, and supplying the main voltage to a main output terminal; and
a main/standby stage converting the main voltage from the DC/DC stage into a second standby voltage having a preset magnitude, and supplying the second standby voltage to the standby output terminal.

6. The power supply of claim 5, wherein the main/standby stage comprises a first diode having an anode connected to the main output terminal and a cathode connected to the standby output terminal, the first diode being turned on by the main voltage from the DC/DC stage and supplying the second standby voltage to the standby output terminal.

7. The power supply of claim 5, wherein the main/standby stage comprises a first switching element connected between the main output terminal and the standby output terminal, the first switching element being turned on by a first switching control signal and supplying the main voltage from the DC/DC stage to the standby output terminal.

8. The power supply of claim 5, wherein the main/standby stage comprises:
a voltage regulator converting the main voltage from the DC/DC stage into a preset voltage; and
a second diode having an anode connected to an output terminal of the voltage regulator and a cathode connected to the standby output terminal, the second diode being turned on by an output voltage of the voltage regulator and supplying the second standby voltage to the standby output terminal.

9. A power supply having improved system efficiency, comprising:
a standby stage converting a DC voltage into an operating voltage and a first standby voltage, which have a preset magnitude, and supplying the first standby voltage to a standby output terminal;
a DC/DC stage supplied with the operating voltage from the standby stage, converting the DC voltage into a main voltage having a preset magnitude, and supplying the main voltage to a main output terminal;
a main/standby stage converting the main voltage from the DC/DC stage into a second standby voltage having a preset magnitude, and supplying the second standby voltage to the standby output terminal; and
a protection circuit unit connected between an output terminal of the standby stage and the standby output terminal, and opening a voltage supply line connected to the output terminal of the standby stage.

10. The power supply of claim 9, further comprising a power factor correction (PFC) unit converting an AC voltage into the DC voltage and supplying the DC voltage to the DC/DC stage and the standby stage.

11. The power supply of claim 9, wherein the main/standby stage comprises a first diode having an anode connected to the main output terminal and a cathode connected to the standby output terminal, the first diode being turned on by the main voltage from the DC/DC stage and supplying the second standby voltage to the standby output terminal.

12. The power supply of claim 11, wherein the protection circuit unit comprises a protection diode having an anode connected to the output terminal of the standby stage and a cathode connected to the standby output terminal, the protection diode being turned off when the second standby voltage is supplied.

13. The power supply of claim 11, wherein the protection circuit unit comprises a protection switching element connected between the output terminal of the standby stage and the standby output terminal, the protection switching element being turned off when the second standby voltage is supplied.

14. The power supply of claim 9, wherein the main/standby stage comprises a first switching element connected between the main output terminal and the standby output terminal, the first switching element being turned on by a first switching control signal and supplying the main voltage from the DC/DC stage to the standby output terminal.

15. The power supply of claim 14, wherein the protection circuit unit comprises a protection diode having an anode connected to the output terminal of the standby stage and a cathode connected to the standby output terminal, the protection diode being turned off when the second standby voltage is supplied.

16. The power supply of claim 14, wherein the protection circuit unit comprises a protection switching element connected between the output terminal of the standby stage and the standby output terminal, the protection switching element being turned off when the second standby voltage is supplied.

17. The power supply of claim 9, wherein the main/standby stage comprises:
a voltage regulator converting the main voltage from the DC/DC stage into a preset voltage; and
a second diode having an anode connected to an output terminal of the voltage regulator and a cathode connected to the standby output terminal, the second diode being turned on by an output voltage of the voltage regulator and supplying the second standby voltage to the standby output terminal.

18. The power supply of claim 17, wherein the protection circuit unit comprises a protection diode having an anode connected to the output terminal of the standby stage and a cathode connected to the standby output terminal, the protection diode being turned off when the second standby voltage is supplied.

19. The power supply of claim 17, wherein the protection circuit unit comprises a protection switching element connected between the output terminal of the standby stage and the standby output terminal, the protection switching element being turned off when the second standby voltage is supplied.
